(19) United States
(12) Patent Application Publication
(10) Pub. No.: US 2014/0014799 A1
(43) Pub. Date: Jan. 16, 2014

(54) TOOL HOLDER

(71) Applicant: George Bertolotti, San Ramon, CA (US)

(72) Inventor: George Bertolotti, San Ramon, CA (US)

(21) Appl. No.: 13/546,632

(22) Filed: Jul. 11, 2012

(51) Int. Cl. F16M 13/02

(52) U.S. Cl. 248/309.1

(57) ABSTRACT

Tool holders are presented including: a tool receiving bracket having a surface, where the surface forms a partial cylinder, the partial cylinder having an upper edge and a lower edge, where the surface includes an opening for receiving a tool, where the opening extends vertically from the upper edge to the lower edge; an attachment portion extending away from the surface with respect to the upper edge and the lower edge; and an accessory hook mechanically coupled with the attachment portion and extending therefrom. In some embodiments, tool holders further include: a connecting arm having a proximal end and a distal end, the proximal end attached with the attachment portion; and a base attached with the distal end of the connecting arm.

### BACKGROUND

Metal Inert Gas (MIG) welding is the most pervasive welding method utilized in modern manufacturing and is suitable for a variety of manufacturing and fabrication processes. A MIG welder operates by feeding wire through a guide to an operator gun or torch. This allows an operator to efficiently and continuously weld long beads. However, during fabrication operations, an operator may be required to pause for any number of reasons such as checking fitment or clearance. When these pauses occur, there is often no safe or practical place to rest a welding gun since the welding gun operates by depressing a trigger, which may be activated when the welding gun is laid down. Many welders have set a welding gun down only to find a significant amount of unspooled wire released and wasted. Compounding the danger is the high pressure gas and high electrical currents that are released or exposed when the trigger is depressed. Safety, productivity, and wasted materials are on-going concerns in utilizing modern welding tools.

As such tool holders are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Tool holders are presented including: a tool receiving bracket having a surface, where the surface forms a partial cylinder, the partial cylinder having an upper edge and a lower edge, where the surface includes an opening for receiving a tool, where the opening extends vertically from the upper edge to the lower edge; an attachment portion extending away from the surface with respect to the upper edge and the lower edge; and an accessory hook mechanically coupled with the attachment portion and extending therefrom. In some embodiments, tool holders further include: a connecting arm having a proximal end and a distal end, the proximal end attached with the attachment portion; and a base attached with the distal end of the connecting arm. In some embodiments, the base includes: a ring arrangement, a platform arrangement, a clamping arrangement, a magnetic arrangement, an angled plate arrangement, a plate arrangement, and a barrel arrangement. In some embodiments, the connecting arm includes: a rigid connecting arm, a telescoping connecting arm, a flexible arm, and an articulating connecting arm. In some embodiments, tools include: a metal inert gas (MIG) welding gun, a tungsten inert gas (TIG) welding torch, a shielded metal arc welding (SMAW) electrode holder, and a gas torch.

In other embodiments, methods of using a tool holder are presented including: locating a tool in the tool bolder, the tool holder including, a tool receiving bracket having a surface, where the surface forms a partial cylinder, the partial cylinder having an upper edge and a lower edge, where the surface includes an opening for receiving the tool, where the opening extends vertically from the upper edge to the lower edge, an attachment portion extending away from the surface with respect to the upper edge and the lower edge, and an accessory hook mechanically coupled with the attachment portion and extending therefrom; and removing the tool from the tool holder. In some embodiments, methods further include: locating a connection assembly in the tool receiving bracket; sliding the tool toward the tool receiving bracket along the connection assembly; and engaging the tool with the tool receiving bracket.

In other embodiments welding tool holders are presented including: a welding tool receiving bracket having a surface, where the surface forms a partial cylinder, the partial cylinder having an upper edge and a lower edge, where the surface includes an opening for receiving a welding tool, where the opening extends vertically from the upper edge to the lower edge; an attachment portion extending away from the surface with respect to the upper edge and the lower edge; an accessory hook mechanically coupled with the attachment portion and extending therefrom; a connecting arm having a proximal end and a distal end, the proximal end attached with the attachment portion; and a base attached with the distal end of the connecting arm.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a tool holder in accordance with embodiments of the present invention;

FIG. 2 is an illustrative representation of a tool holder in accordance with embodiments of the present invention;

FIG. 3 is an illustrative representation of various bases for tool holders in accordance with embodiments of the present invention; and

FIGS. 4A-4C are illustrative representations of a method of use for tool holders in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

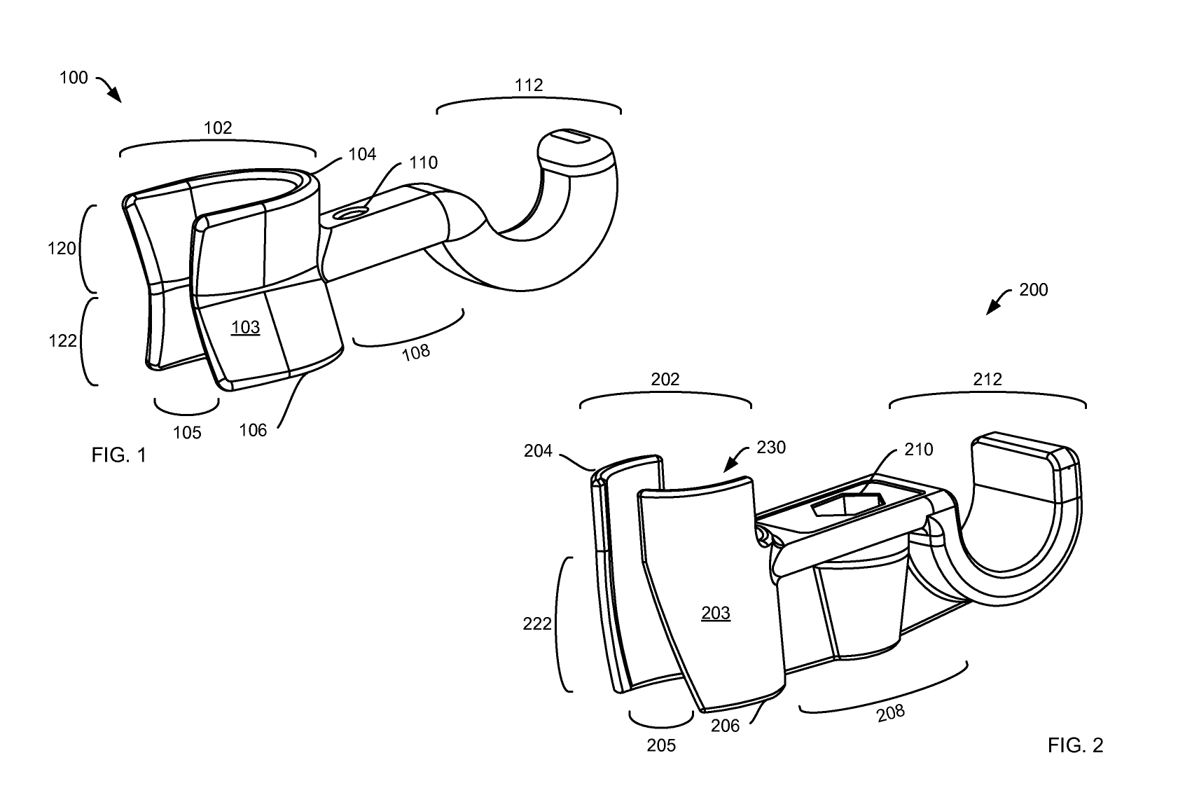

FIG. 1 is an illustrative representation of a tool holder 100 in accordance with embodiments of the present invention. As illustrated, tool holder 100 includes tool receiving bracket 102 having surface 103 that forms a partial cylinder. In turn, surface 103 includes at least the following elements: upper edge 104, lower edge 106, and opening 105. As illustrated, opening 105 extends vertically from upper edge 104 to lower edge 106. It may be appreciated that the use of terms for describing configuration are for illustrative purposes only and should not be construed as limiting. For example, although the term “vertically” is utilized to describe the opening in a particular configuration, the term should not be construed to require any particular spatial orientation. In some embodiments, opening may be upwardly flared 120, or downwardly flared 122 or both upwardly and downwardly flared as illustrated. It may be appreciated that flaring may allow a tool such as a welding tool to be more easily received and released. However, in some embodiments, flaring is not utilized or required. In some embodiments, the partial cylinder may have a diameter in a range of 0.5 inches to 2.5 inches. In some embodiments, the opening may have a width in a range of 0.5 inches to 2.5 inches.

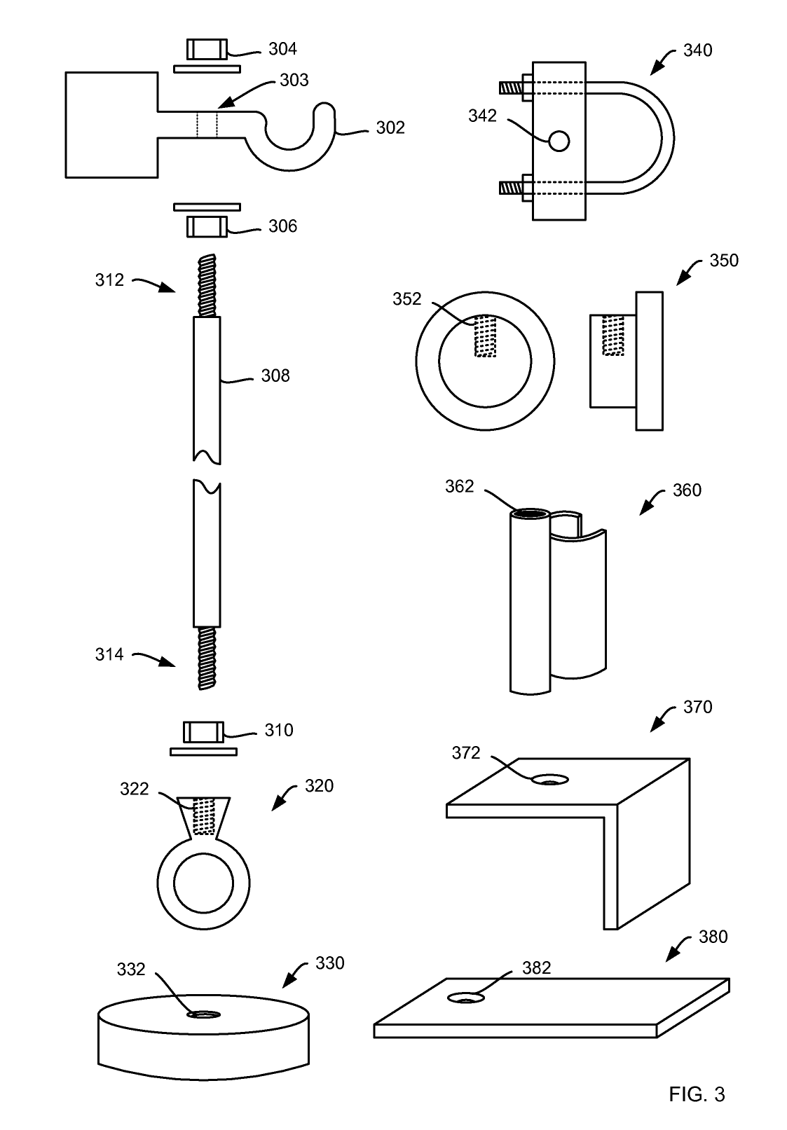

Further illustrated is attachment portion 108 that extends away from surface 103 with respect to upper edge 104 and lower edge 106. As illustrated, attachment portion 108 includes hole feature 110 for attachment with a connecting arm and a base. Connecting arms and bases will be discussed in further detail below for FIG. 3. In some embodiments, attachment portions may include other features such as: a slot feature, a molded nut feature, a molded bolt feature, an articulating feature, and a threaded feature without limitation. In still other embodiments not illustrated, tool holders may include a belt attachment in mechanical communication with attachment portion 108. It may be appreciated that some belt attachment embodiments lack an accessory hook such as those illustrated here.

Still further as illustrated, accessory hook 112 may be mechanically coupled with attachment portion 108 and extend therefrom. It may be appreciated that accessory hook 112 may extend in any direction from attachment portion 108 without departing from embodiments provided herein. In some embodiments, accessory hook 112 may further include a retention strap (not illustrated) for securing an accessory or cable. In some embodiments, tool holder 100 may be suitable for temporarily securing a variety of welding tools including: a metal inert gas (MIG) welding gun, a tungsten inert gas (TIG) welding torch, a shielded metal arc welding (SMAW) electrode holder, and a gas torch. It may be appreciated tool holder 100 may be manufactured utilizing any number of processes without departing from embodiments provided herein such as, for example, injection molding, casting, machining, 3D printing, and the like.

FIG. 2 is an illustrative representation of a tool holder 200 in accordance with embodiments of the present invention. As illustrated, tool holder 200 includes tool receiving bracket 202 having surface 203 that forms a partial cylinder. In turn, surface 203 includes at least the following elements: upper edge 204, lower edge 206, and opening 205. As illustrated, opening 205 extends vertically from upper edge 204 to lower edge 206. It may be appreciated that the use of terms describing configuration are for illustrative purposes only and should not be construed as limiting. For example, although the term “vertically” is utilized to describe the opening in a particular configuration, the term should not be construed to require any particular spatial orientation. In some embodiments, surface 203 may further include cutaway portion 230 that extends from upper edge 204 and proximate with attachment portion 208. In other embodiments, surface 203 may further include a widened opening cutaway portion 222 that extends along the opening downward toward lower edge 206. It may be appreciated that a cutaway portion and a widened opening cutaway portion provides additional clearance that may allow a tool such as a welding tool to be more easily received and released. However, some embodiments have no cutaway portions. In some embodiments, the partial cylinder may have a diameter in a range of 0.5 inches to 2.5 inches. In some embodiments, the opening may have a width in a range of 0.5 inches to 2.5 inches.

Further illustrated is attachment portion 208 that extends away from surface 203 with respect to upper edge 204 and lower edge 206. As illustrated, attachment portion 208 includes molded nut feature 210 for attachment with a connecting arm and a base. Connecting arms and bases will be discussed in further detail below for FIG. 3. In some embodiments, attachment portions may include other features such as: a hole feature, a slot feature, a molded bolt feature, an articulating feature, and a threaded feature without limitation. In still other embodiments not illustrated, tool holders may include a belt attachment in mechanical communication with attachment portion 208. It may be appreciated that some belt attachment embodiments lack an accessory hook such as those illustrated here.

Still further as illustrated, accessory hook 212 may be mechanically coupled with attachment portion 208 and extend therefrom. It may be appreciated that accessory hook 212 may extend in any direction from attachment portion 208 without departing from embodiments provided herein. In some embodiments, accessory hook 212 may further include a retention strap (not illustrated) for securing an accessory or cable. In some embodiments, tool holder 200 may be suitable for temporarily securing a variety of welding tools including: a MIG welding gun, a TIG welding torch, an SMAW electrode holder, and a gas torch. It may be appreciated tool holder 200 may be manufactured utilizing any number of processes without departing from embodiments provided herein such as, for example, injection molding, casting, machining, 3D printing, and the like.

FIG. 3 is an illustrative representation of various bases for tool holders in accordance with embodiments of the present invention. As noted above, tool holders may further include connecting arms and bases. As illustrated, connecting arm 308 may include proximal end 312 and distal end 314. Proximal end 312 of connecting arm 308 may be attached with tool holder 302 at attachment portion 303. Nuts 304, 306, and 310 may be utilized for attaching, locking, or otherwise adjusting fitment of tool holder embodiments. The nuts shown are for illustrative purposes only and should not be construed as limiting with respect to size, shape, type, or number. It may be appreciated that connecting arms may be embodied in various ways without departing from embodiments herein and may include: a rigid connecting arm (illustrated), a telescoping connecting arm (not illustrated), a flexible arm (not illustrated), and an articulating connecting arm (not illustrated). Further as illustrated, connecting arm embodiments may be attached with any number of base embodiments at distal end 314. Base embodiments may include any number of arrangements such as, for example, a ring arrangement 320, a platform arrangement 330, a clamping arrangement 340, a magnetic arrangement 350, a barrel arrangement 360, an angled plate arrangement 370, and a flat plate arrangement 380 without departing from embodiments disclosed herein.

In operation, ring arrangement 320 may be useful in providing an open attachment point for storing or otherwise attaching tool holder embodiments with a stationary surface or object or a mobile surface or object. Ring arrangement 320 may include a threaded portion 322 for receiving connecting arm 308 or may be configured to slidingly engage connecting arm embodiments. Further, platform arrangement 330 may be useful in providing an independent support on a surface or substrate. It may be appreciated that platform arrangements may include any number of shapes, sizes, or weights without departing from present embodiments. Platform arrangement 330 may include a threaded portion 332 for receiving connecting arm 308 or may be configured to slidingly engage connecting arm embodiments. Clamping arrangement 340 may be useful in providing an attachment point with a pipe, conduit, tube, strap, or rod surface. Clamping arrangement 340 may include a threaded portion 342 for receiving connecting arm 308 or may be configured to slidingly engage connecting arm embodiments.

Still further, in operation, magnetic arrangement 350 may be useful in providing an attachment point with a magnetically sensitive surface. Magnetic arrangement 350 may include a threaded portion 352 for receiving connecting arm 308 or may be configured to slidingly engage connecting arm embodiments. Further, barrel arrangement 360 may be useful in providing an attachment point with a rounded surface such as a pipe or conduit. Barrel arrangement 360 may slidingly engage connecting arm embodiments at shaft 362 or may be configured to threadingly engage connecting arm embodiments. Still further, angled plate arrangement 370 may be useful in providing an attachment point with vertical surfaces. Angled plate arrangement may be attached with a vertical surface in any manner known in the art without departing from embodiments herein. Angled plate arrangement 370 may slidingly engage connecting arm embodiments at point 372 or may be configured to threadingly engage connecting arm embodiments. Still further, flat plate arrangement 380 may be useful in providing an attachment point with horizontal surfaces. Flat plate arrangement may be attached with a horizontal surface in any manner known in the art without departing from embodiments herein. Flat plate arrangement 380 may slidingly engage connecting arm embodiments at point 382 or may be configured to threadingly engage connecting arm embodiments.

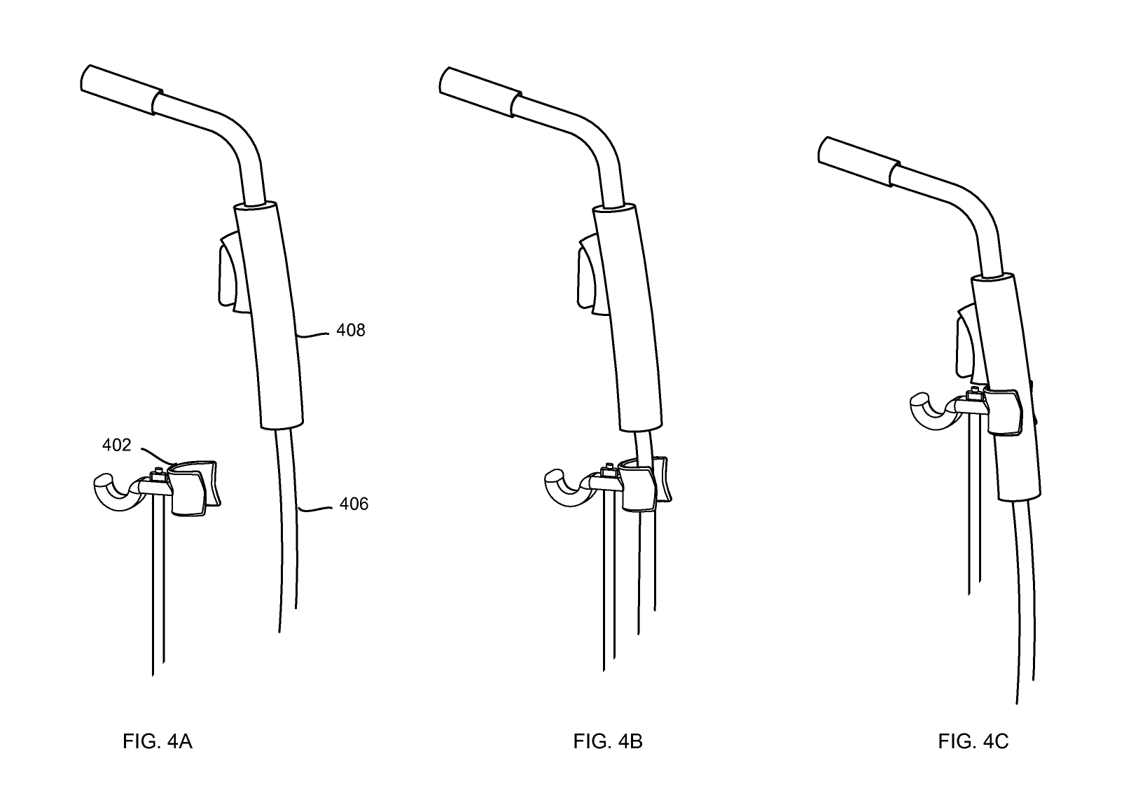

FIGS. 4A-4C are illustrative representations of a method of use for tool holders in accordance with embodiments of the present invention. As illustrated in FIG. 4A, tool 408 is in proximity with tool holder embodiments 402 as disclosed herein. In the illustration, a MIG gun is in proximity with the tool holder, however, other tools such as, a TIG welding torch, an SMAW electrode holder, and a gas torch may be utilized without departing from embodiments provided herein. An operator may locate connection assembly 406 in tool receiving bracket as illustrated in FIG. 4B. Connection assemblies may include: a hose, a wire guide, a power cable, and a process cable without departing from embodiments provided herein. In some embodiments, the opening is sized narrowly enough to prevent release of a tool, but wide enough to receive a connection assembly. An operator may then slide the tool toward the receiving bracket along the connection assembly to engage the tool with the tool receiving bracket as illustrated in FIG. 4C. Tool 408 may subsequently be removed from tool holder 402 by an operator. In some embodiments, an operator may utilize accessory hooks for hanging a portion of a connecting assembly or some other accessory such as a helmet for example. In still other embodiments, an operator may attach tool holder 402 to a stationary or mobile surface via attachment point as disclosed above.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

1. A tool holder comprising:
a tool receiving bracket having a surface, wherein
the surface forms a partial cylinder, the partial cylinder having an upper edge and a lower edge, wherein
the surface includes an opening for receiving a tool, wherein
the opening extends vertically from the upper edge to the lower edge;
an attachment portion extending away from the surface with respect to the upper edge and the lower edge; and
an accessory hook mechanically coupled with the attachment portion and extending therefrom.

2. The tool holder of claim 1, further comprising:
a connecting arm having a proximal end and a distal end, the proximal end attached with the attachment portion; and
a base attached with the distal end of the connecting arm.

3. The tool holder of claim 2, wherein the base is selected from the group consisting of: a ring arrangement, a platform arrangement, a clamping arrangement, a magnetic arrangement, an angled plate arrangement, a plate arrangement, and as barrel arrangement.

4. The tool holder of claim 2, wherein the connecting arm is selected from the group consisting of: a rigid connecting arm, a telescoping connecting arm, a flexible arm, and an articulating connecting arm.

5. The tool holder of claim 1, wherein the partial cylinder further comprises a cutaway portion extending from the upper edge downward, wherein the cutaway portion is located proximate with the attachment portion.

6. The tool holder of claim 1, wherein the opening is upwardly and downwardly flared such that the tool is more easily received and released.

7. The tool holder of claim 1, wherein the attachment point includes a feature selected from the group consisting of: a hole feature, a slot feature, a molded nut feature, a molded bolt feature, an articulating feature, and a threaded feature.

8. The tool holder of claim 1, wherein the partial cylinder has a diameter in a range of 0.5 inches to 2.5 inches.

9. The tool holder of claim 1, wherein the opening has a width in a range of 0.5 inches to 2.5 inches.

10. The tool holder of claim 1, further comprising a belt attachment in mechanical communication with the attachment portion.

11. The tool holder of claim 1, wherein the tool is selected from the group consisting of: a metal inert gas (MIG) welding gun, a tungsten inert gas (TIG) welding torch, a shielded metal arc welding (SMAW) electrode holder, and a gas torch.

12. The tool holder of claim 1, wherein the accessory hook further comprises a retention strap for securing an accessory.

13. A method of using a tool holder comprising:
locating a tool in the tool holder, the tool holder including,
a tool receiving bracket having a surface, wherein
the surface forms a partial cylinder. the partial cylinder having an upper edge and a lower edge, wherein
the surface includes an opening for receiving the tool, wherein
the opening extends vertically from the upper edge to the lower edge,
an attachment portion extending away from the surface with respect to the upper edge and the lower edge, and
an accessory hook mechanically coupled with the attachment portion and extending therefrom; and
removing the tool from the tool holder.

14. The method of claim 13, wherein the locating further composes:
locating a connection assembly in the tool receiving bracket;
sliding the tool toward the tool receiving bracket along the connection assembly: and
engaging the tool with the tool receiving bracket.

15. The method of claim 14, wherein the connection assembly is selected from the group consisting of a hose, a wire guide, a power cable, and a process cable.

16. The method of claim 13, wherein the tool is selected from the group consisting of: a metal inert gas (MIG) welding gun, a tungsten inert gas (TIG) welding torch, a shielded metal arc welding (SMAW) electrode holder, and a gas torch.

17. The method of claim 13 further comprising:
attaching the tool holder with a stationary surface, the tool holder further including,
a connecting arm having a proximal end and a distal end, the proximal end attached with the attachment portion, and
a base attached with the distal end of the connecting arm, wherein the base is selected from the groups consisting of it ring arrangement, a platform arrangement, a clamping arrangement, a magnetic arrangement, an angled plate arrangement, a plate arrangement, and a barrel arrangement, and wherein the base is attached with the stationary surface.

18. A welding tool holder comprising:
a welding tool receiving bracket having a surface, wherein
the surface forms a partial cylinder,. the partial cylinder having an upper edge and a lower edge, wherein
the surface includes an opening for receiving a welding tool, wherein
the opening extends vertically from the upper edge to the lower edge;
an attachment portion extending away from the surface with respect to the upper edge and the lower edge;
an accessory hook mechanically coupled with the attachment portion and extending therefrom;
a connecting arm having a proximal end and a distal end, the proximal end attached with the attachment portion; and
a base attached with the distal end of the connecting arm.

19. The welding tool holder of claim 1, wherein the welding tool is selected from the group consisting of: a metal inert gas (MIG) welding gun, a tungsten inert gas (TIG) welding torch, a shielded metal arc welding (SMAW) electrode holder, and a gas torch.

20. The welding tool holder of claim 19, further comprising:
a connecting arm having a proximal end and a distal end, the proximal end attached with the attachment portion; and
a base attached with the distal end of the connecting arm.

21. The welding tool holder of claim 19, wherein the connecting arm is selected from the group consisting of a rigid connecting arm, a telescoping connecting arm, a flexible arm, and an articulating connecting arm.

22. The welding tool holder of claim 19, wherein the partial cylinder further comprises a cutaway portion extending from the upper edge downward, wherein the cutaway portion is located proximate with the attachment portion.

23. The welding tool holder of claim 19, wherein the opening is upwardly and downwardly flared such that the welding tool is more easily received and released.

24. The welding tool holder of claim 19, wherein the attachment point includes a feature selected from the group consisting of: a hole feature, a slot, feature, a molded nut feature, a molded bolt feature, an articulating feature, and a threaded feature.

25. The welding tool holder of claim 19, wherein the partial cylinder has a diameter in a range of 0.5 inches to 2.5 inches.

26. The welding tool holder of claim 19, wherein the opening has a width in a range of 0.5 inches to 2.5 inches.

27. The welding tool holder of claim 19, further comprising a belt attachment in mechanical communication with the attachment portion.
